(19) United States
(12) Patent Application Publication
(10) Pub. No.: US 2013/0014042 A1
(43) Pub. Date: Jan. 10, 2013

(54) METHOD AND APPARATUS FOR ADJUSTING SIZE OF A LIST ITEM

(75) Inventors: Min Ren, Shenzhen City (CN); Weiwen Xie, Shenzhen (CN)

(73) Assignee: TENCENT TECHNOLOGY (SHENZHEN) COMPANY LIMITED, Shenzhen (CN)

(21) Appl. No.: 13/616,771

(22) Filed: Sep. 14, 2012

Related U.S. Application Data
(63) Continuation of application No. PCT/CN2011/071634, filed on Mar. 9, 2011.

(30) Foreign Application Priority Data
Jun. 3, 2010 (CN) 201010190692.2

(51) Int. Cl. G06F 3/048

(52) U.S. Cl. 715/765

(57) ABSTRACT

The present invention provides method and apparatus for adjusting size of a list item displayed on a touchscreen. The method may include obtaining, by a client application, a multi-touch event, adjusting the size of a head portrait control and the size of a contact panel control in the list item according to at least one event parameter in the multi-touch event. The apparatus for adjusting the size of the list item may include: an obtaining module for obtaining a multi-touch event; and an adjusting module for adjusting the size of a head portrait control and the size of a contact panel control in the list item according to at least one event parameter in the multi-touch event obtained by the obtaining module.

The present invention claims priority of Chinese patent application No. 201010190692.2 filed on Jun. 3, 2010 with the Patent Office of the People's Republic of China with a title of “method and apparatus for adjusting size of a list item”, the disclosure of which is incorporated by reference in its entirety for all purposes.

### TECHNICAL FIELD

The present invention relates to computer technology, and particularly to a method and an apparatus for adjusting the size of a list item.

### BACKGROUND

With developments in the Internet and with influences of the Internet spreading, IM (Instant Messaging) tools have been widely used in working and entertainment by most Internet users and become an indispensible software tool. Users call for IM terminals with high usability, high reliability and high security.

In order to meet individual requirements of users, most IM terminals allow users to use user-defined head portraits. For example, QQ (an IM tool) supports head portraits with different sizes, such as 16×16, 40×40, 100×100, 640×640 and so on. In a contact list of an IM tool, each list item represents a contact. Besides a head portrait of a contact, multiple pieces of information may be displayed in a list item, e.g., an ID, a nickname, a personal signature, Blog latest update, the music being played of the contact and so on. A user may configure the display size of a head portrait of a contact by making a selection in a menu according to his/her own preferences.

With development in technologies, touch control devices are becoming more and more popular, and people are getting used to operating a device through touch or multi-touch operation. Touch operations are easy to learn, and especially suitable for use by elderly people and children. Being a commonly used software, it is an inevitable trend for IM tools to support touch control. However, IM as computer software, have generally more complex functions, operations and user interfaces than a software installed in a handset.

Furthermore, touch operations are quite different from mouse operations, e.g., touch operations may include click, dragging and scrolling operations, but do not include operations similar to, for example, click by right mouse button, mouse point and etc. The dragging operation is implemented by a finger selecting an element in a software interface and moving the element, such as dragging to move a file, or dragging a list item to change the position of a contact and so on. The scrolling operation can be implemented by a finger placed on an interface with a sliding bar and making the sliding bar to scroll in the direction of the movement of the finger. A user may scroll a sliding bar pre-set in a contact list to check each list item in the contact list. In addition, through a click operation on a “Blog latest update” in a list item, the Blog of a contact can be accessed; by a click on “music being played” in a list item, a QQ music program can be started; and by a click on other areas in a list item, list items in the area can be selected.

In the prior art, an IM client installed in a touch control device can not adjust the size of a list item, and is not easy to use. When an IM client installed in a non-touch control device adjusts the size of a list item, the process that the display size of the head portrait of a contact changes is abrupt and broken, which reduces quality experience of users and makes the IM client not easy to use.

### SUMMARY

The present invention provides a method and an apparatus for adjusting the size of a list item to make an IM client easier to use.

The method for adjusting the size of a list item displayed on a touchscreen, the list item comprising a head portrait control and a contact panel control, the method comprising:

obtaining, by a client application, a multi-touch event; and

adjusting, by the client application, a size of the head portrait control and a size of the contact panel control according to at least one event parameter in the multi-touch event.

The apparatus for adjusting a size of a list item being displayed on a touchscreen, the list item comprising a head portrait control and a contact panel control, the apparatus comprising:

an obtaining module adapted to obtain a multi-touch event; and

an adjusting module adapted to adjust a size of the head portrait control and a size of the contact panel control according to at least one event parameter in the multi-touch event.

Embodiment of the present invention also provide a non-transitory computer readable medium storing instructions executable by a processor, the instructions comprising instructions for a client application to adjust size of a list item displayed on a touchscreen, the list item comprising a head portrait control and a contact panel control:

obtaining a multi-touch event; and

adjusting a size of the head portrait control and a size of the contact panel control according to at least one event parameter in the multi-touch event.

Compared with the prior art, the technical scheme of the present invention has the following advantages: a list item is adjusted via a multi-touch event while it is ensured that the multi-touch event is compatible with existing operations, which makes the IM client easier to use.

### BRIEF DESCRIPTION OF THE DRAWINGS

FIG. 1a is a schematic diagram illustrating a zoom-in operation corresponding to a multi-touch event according to an embodiment of the present invention.

FIG. 1b is a schematic diagram illustrating a zoom-out operation corresponding to a multi-touch event according to an embodiment of the present invention.

FIG. 2 is a flowchart illustrating a method for adjusting the size of a list item according to an embodiment of the present invention.

FIG. 3 is a schematic diagram illustrating position information of a multi-touch event corresponding to a zoom-in operation in an application scenario according to an embodiment of the present invention.

FIG. 4a is a schematic diagram illustrating a layout of sub elements of a contact panel control when a head portrait control is displayed in a large size mode in an application scenario according to an embodiment of the present invention.

FIG. 4b is a schematic diagram illustrating a layout of sub elements of a contact panel control when a head portrait control is displayed in a small size mode in an application scenario according to an embodiment of the present invention.

FIG. 5 is a schematic diagram illustrating a layout of a template when the size of a head portrait of a contact is 40×40 in an application scenario according to an embodiment of the present invention.

FIG. 6 is a schematic diagram illustrating a layout of a template when the size of a head portrait of a contact is 60×60 in an application scenario according to an embodiment of the present invention.

FIG. 7 is a schematic diagram illustrating a structure of an apparatus for adjusting the size of a list item according to an embodiment of the present invention.

### EMBODIMENTS OF THE INVENTION

Embodiments of the present invention provide a technical scheme for adjusting the size of a list item in a contact list of an IM client by utilizing multi-touch techniques. According to operation habits of users, a list item in a complex list control which includes various types of elements is adjusted through a multi-touch operation while it is ensured that the multi-touch operation does not conflict with existing dragging operations, scrolling operations and clicking operations to avoid incorrect operations, i.e., keeping the multi-touch operation compatible with existing operations of a touch control device without influence on existing operations and making the IM client much easier to use. In addition, the list item may be adjusted at pre-set intervals, e.g. zoom in or zoom out a head portrait in the contact list smoothly and steplessly. While the size of the head portrait is adjusted, the display layout of all elements in the list item are also adjusted smoothly to make the user interface of the IM client highly functional and look neat, thus to improve service experience of users.

Technical schemes provided by embodiments of the present invention are hereinafter described clearly and completely in detail with reference to the accompanying drawings. It should be understood that the embodiments described are merely some embodiments of the present invention, not all of the embodiments. Based on the embodiments of the present invention, other embodiments obtained by those skilled in the art without any inventive work done are still within the protection scope of the present invention.

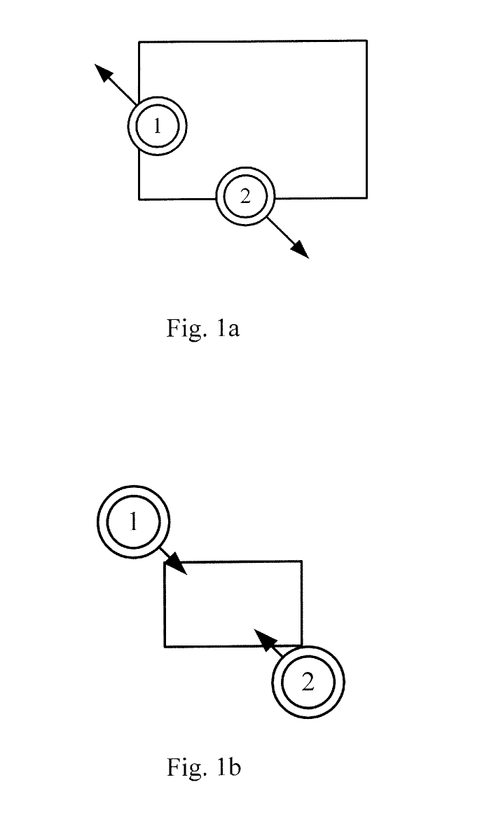

The method for adjusting the size of a list item may be applied to a client application running on a touch control device. A zoom in/out operation corresponding to a multi-touch event may be implemented by two fingers or stylus pens placed on a touchscreen and moving away from or towards each other. As shown in FIG. 1a and FIG. 1b, two fingers or touch pens moving towards each other implements a zoom-out operation; and two fingers or touch pens moving away from each other implements a zoom-in operation. In a client application running on a touch control device, the client application regards a touch by a finger or a stylus pen as a mouse event (e.g. a mouse button pressed, a mouse moving, a mouse button released and etc.) by default. If various operations applied to the touch control device are processed based on mouse events, a zoom in/out operation corresponding to a multi-touch event may be confused with existing operations of dragging, scrolling and clicking, thus results in conflicting and incorrect operations. Therefore, the zoom in/out operation corresponding to a multi-touch event may be distinguished from other operations by a determination as to whether a touch event occurred is a multi-touch event. In Windows systems, all events are implemented through Windows messaging schemes, thus an embodiment of the present invention analyzes the operation of a touch event occurred on a message basis. Multi-touch events may be intercepted and analyzed separately with no mouse event messages sent to the client application. Events other than multi-touch events may be processed in system default manners, i.e. by sending a mouse event message to the client application.

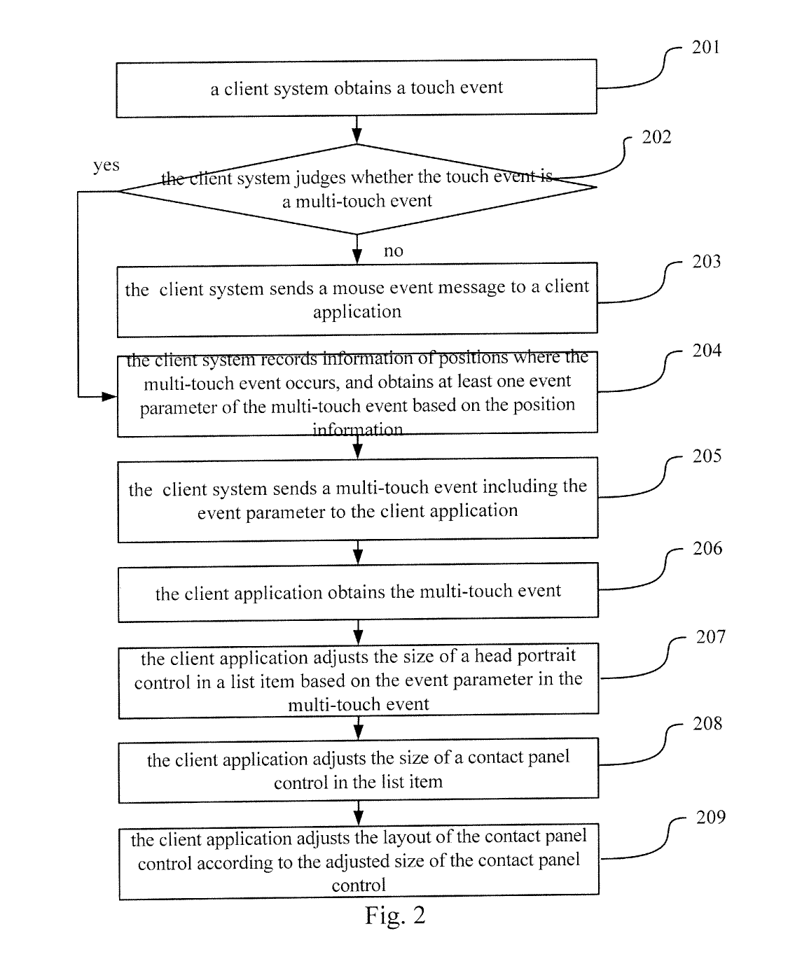

FIG. 2 is a flowchart illustrating a method for adjusting the size of a list item according to an embodiment of the present invention. The method may include the following procedures.

In block 201, a client device obtains a touch event.

The touch event may be obtained by a client system, and may be a finger press message or a stylus pen press message.

In block 202, the client system judges whether the touch event obtained is a multi-touch event, performs procedures in block 204 in response to a determination that the touch event obtained is a multi-touch event, and performs procedures in block 203 in response to a determination that the touch event obtained is not a multi-touch event.

Specifically, the client system may obtain the number of touch points of the touch event, and determines the touch event is not a multi-touch event if the number of touch points is one; determines the touch event is a multi-touch event if the number of touch points is larger than one.

In block 203, the client system sends a mouse event message to the client application.

In block 204, the client system records information of the positions where the multi-touch event occurs, and obtains one or more parameters of the multi-touch event based on the positions.

Specifically, when determining the touch event is a multi-touch event, the client system may obtain and record information of positions where the multi-touch event occurs according to a pre-set period T, i.e. information of the movement of fingers or stylus pens, until the fingers or the stylus pens leave the screen. The client system may obtain one or multiple parameters of the multi-touch event according to information of the positions recorded in each period.

The multi-touch event may be a two-touch event, and the parameters of the multi-touch event may include a center point and a zoom scale of a zoom in/out operation corresponding to a multi-touch event. The client system may obtain information of initial positions of two touch points on the screen before the movement and information of final positions of the two touch points after the movement, take the position of the mid-point between the initial positions as the center point of the zoom in/out operation, and take the ratio of the distance between the two touch points after the movement to the distance between the two touch points before the movement as the zoom scale of the zoom in/out operation.

FIG. 3 is a schematic diagram illustrating information of positions of a multi-touch event corresponding to a zooming in operation. Information of initial positions includes an initial position 1 of a first touch point and an initial position 2 of a second touch point with a distance of L1 in between, a final position 3 of the first touch point and a final position 4 of the second touch point with a distance of L2 in between. And the center of the zoom-in operation is the mid-point between the position 1 and the position 2, and the zoom scale=L2/L1.

In block 205, the client system sends a multi-touch event to the client application together with the parameters.

In block 206, the client application obtains the multi-touch event.

In block 207, the client application adjusts the size of a head portrait control of a list item according to the parameters of the multi-touch event.

Specifically, the client may adjust the size of the head portrait control according to the zoom scale obtained from the multi-touch event, and determine the position of the adjusted head portrait control according to the center point calculated. Since the client application may receive multi-touch events at pre-set intervals from the client system, the client application is able to adjust the size of the head portrait control, denoted by ImageControl, of the list item dynamically at pre-set intervals according to the parameters of the multi-touch events, and the adjusting may adopt the formulas below.

ImageControl.Height=ImageControl.Height*Scale;

ImageControl.Width=ImageControl.Width*Scale;

In the above formulas, ImageControl.Height represents the height of the head portrait, and ImageControl.Width represents the width of the head portrait. When the pre-set period T is relatively small, the zoom scale each time calculated for adjusting the size of the head portrait control is also relatively small, thus resulting in stepless zoom of the head portrait control when the application is running. In practice, the calculated sizes of the head portrait may be mapped to pre-set sizes, and the size of the head portrait is adjusted to a pre-set size which is closest to the size calculated. After adjusting the size of the head portrait control, the client application may also determine the position of the head portrait control after the adjustment based on the center point.

In block 208, the client application adjusts the size of a contact panel control in the list item.

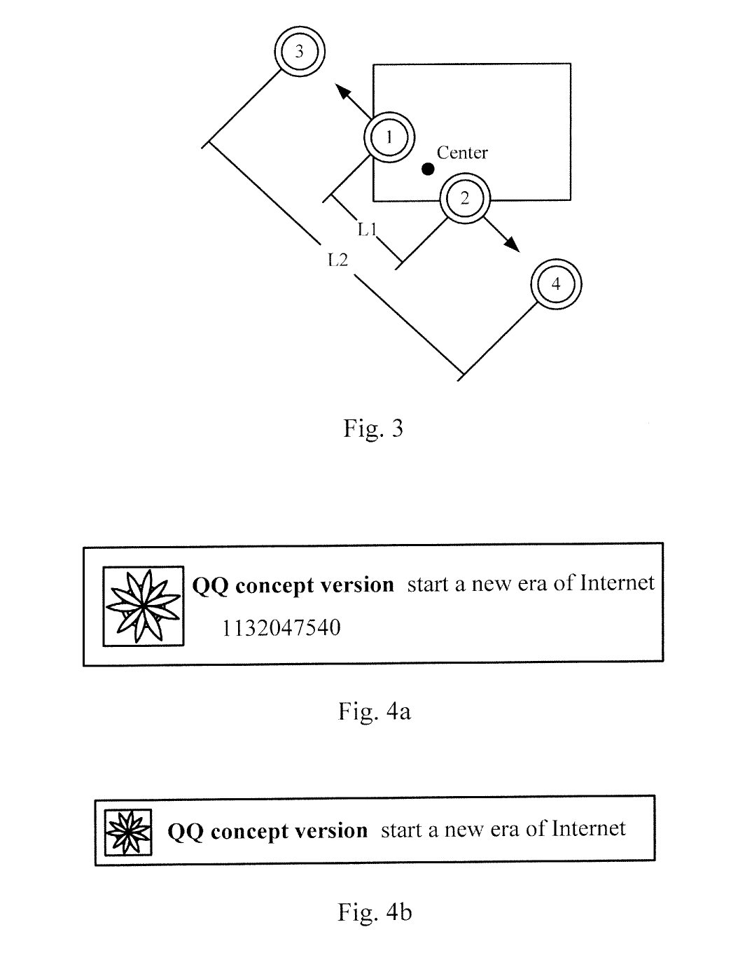

Specifically, a list item may include other elements besides the head portrait control ImageControl, such as a contact ID, a nickname and a signature, and so on. Therefore, the list item may further include a contact panel control, denoted by ConactPanel, for displaying controls of other elements besides the head portrait control in the list item. Elements such as an ID, a nickname and a signature of a contact are sub elements of the ContactPanel. Layout manner of the sub elements of the ContactPanel may be stored in a pre-defined template. In an embodiment of the present invention, different layout manners of sub elements of the ContactPanel may be stored in multiple templates based on different sizes of the head portrait control to be displayed. As shown in FIG. 4a, when the head portrait control is displayed in a large size mode, sub elements of the ContactPanel are displayed in 2 rows; when the head portrait control is displayed in a small size mode, sub elements of the ContactPanel are displayed in 1 row, as shown in FIG. 4b.

Therefore, a list item, denoted by Item, may include two controls denoted by ImageControl and ContactPanel respectively. As the size of each list item is determined by the size of the head portrait control of the list item, adjustment on the size of each list item is performed corresponding to the adjustment on the size of the head portrait control. The client application may adjust the size of the contact panel control based on the size of the adjusted head portrait control and the size of the adjusted list item. The height and the width of the contact panel control after the adjustment may be denoted as availableHeight and availableWidth respectively.

In block 209, the client application adjusts the layout of the contact panel control according to the adjusted size of the contact panel control.

Specifically, the client application may obtain a pre-defined template, and based on the size and position defined in the pre-defined template for each sub element, obtain a desired overall size of the contact panel control for displaying the contact panel with the adjusted size using the template. When the overall size of the contact panel control displayed using the template is not larger than the adjusted size of the contact panel control, the client application may display the contact panel control by using the template; when the size of the contact panel control displayed using the template is larger than the adjusted size of the contact panel control, the client application may obtain and check other pre-defined templates until the desired overall size of the contact panel control for displaying using the second template is not larger than the adjusted size of the contact panel control.

During the process, the client application may need to re-arrange the sub elements in the ContactPanel such as an ID, a nickname and a signature of the contact. For example, the client application may obtain a pre-defined template. The client application also obtains, from the template and based on the configurations of the template, the desired size and position of each sub element for displaying the sub element using the template. The client application further obtains a minimal desired height, denoted by desiredHeight, and a minimal desired width, denoted by desiredWidth, of the ContactPanel for displaying the sub elements according to the desired size and position of each sub element.

If desired Height>availableHeight

or

desiredWidth>availableWidth,

it means not all contents of the ContactPanel can be displayed by using the template, it is necessary to try other templates and re-calculate the desiredHeight and desiredWidth. If the desiredHeight and the desiredWidth satisfy the following conditions:

desiredHeight<=availableHeight

and

desiredWidth<=availableWidth,

all sub elements of the ContactPanel are arranged and displayed according to the template.

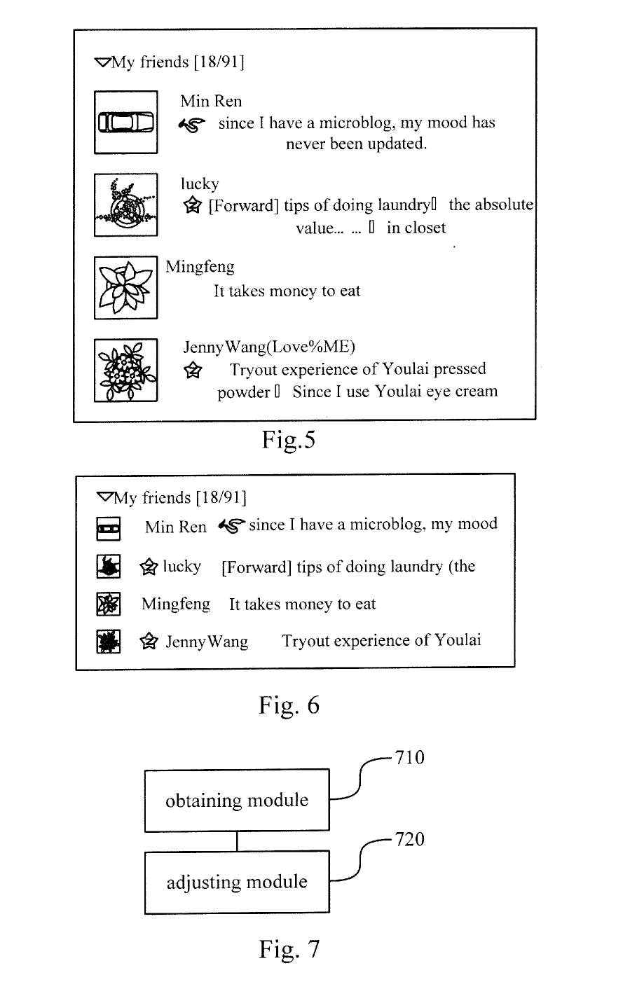

In addition, multiple templates may be defined during program designing to implement stepless switches between different templates. FIG. 5 and FIG. 6 are schematic diagrams illustrating layouts of head portraits of QQ contacts as defined in templates with sizes being 40×40 and 16×16 respectively. In addition, the client application may define a template for the minimal supported size. When the adjusted size of the contact panel control equals or is less than the pre-defined minimal size, the client may use the template for the minimal supported size to display the contact panel control so that all the sub elements can be displayed properly when the ContactPanel is in the minimal size.

It can be seen that the technical scheme of the present invention has the following advantages: a list element is adjusted via a multi-touch event while it is ensured that the multi-touch event is compatible with existing operations, which makes the IM client easier to use. In addition, a list item is adjusted at pre-defined intervals, and a head portrait in a contact list can be zoomed smoothly and steplessly. While the size of the head portrait is adjusted, the layout of all contents included in the list item is also adjusted smoothly to make the user interface of the IM client highly functional and look neat, and thus improves user experience.

The above embodiments of the present invention provide methods for adjusting the size of a list item and corresponding application scenarios, and accordingly, an embodiment of the present invention also provides an apparatus implementing the above methods for adjusting the size of a list item.

FIG. 7 is a schematic diagram illustrating a structure of an apparatus for adjusting the size of a list item according to an embodiment of the present invention. The apparatus may include the following components:

an obtaining module 710 for obtaining a multi-touch event; and

an adjusting module 720 for adjusting the size of a head portrait control and the size of a contact panel control according to at least one event parameter in the multi-touch event obtained by the obtaining module 710.

The multi-touch event may be a two-touch event, and the event parameters of the multi-touch event may include a center point and a zoom scale of a zoom in/out operation corresponding to a multi-touch event.

The obtaining module 710 may obtain information of initial positions of two touch points on the screen before the movement of the two touch points and information of final positions of the two touch points after the movement, take the position of the mid-point of the initial positions as the center point of the zoom operation, and take the ratio of the distance between the two touch points after the movement to the distance between the two touch points before the movement as the zoom scale of the zoom operation.

Accordingly, the adjusting module 702 may adjust the size of the head portrait control according to the zoom scale, and determine the position of the head portrait control after the adjustment based on the center point.

The adjusting module 720 may further adjust the layout of the contact panel control according to the adjusted size of the contact panel control.

The contact panel control may include multiple sub elements. The adjusting module 720 may obtain a pre-defined template, and obtain the desired size of the contact panel control for displaying the contact panel using the template according to the size and position of each sub element defined in the template; when the desired size of the contact panel control displayed using the template is not larger than the adjusted size of the contact panel control, display the contact panel control by using the template; when the desired size of the contact panel control displayed using the template is larger than the adjusted size of the contact panel control, obtain and check another pre-defined template until the desired size of the contact panel control displayed by using the another template is not larger than the adjusted size of the contact panel control.

The adjusting module 720 may further use a template for a pre-defined minimal size to display the contact panel control when the adjusted size of the contact panel control equals or is less than the pre-defined minimal size.

It can be seen that the technical scheme of the present invention adjusts a list element according to a multi-touch event while keeping the multi-touch event compatible with existing operations, which makes the IM client easier to use. In addition, a list item is adjusted at pre-defined intervals, and head portrait in a contact list can be zoomed smoothly and steplessly. While the size of the head portrait is adjusted, the layout of all contents included in the list item is also adjusted smoothly to make the user interface of the IM client highly functional and look neat, and thus improves user experience.

Through the above descriptions, those skilled in the art can clearly understand that the present invention can be implemented by software together with a general hardware platform, or by hardware, where in most cases, the former is preferred. Based on such understanding, in the technical scheme of the present invention, the portions making substantial contributions to the prior art may be embodied in the form of software products. The software product may be stored in a storage medium, and may include instructions to cause a terminal device (e.g. a handset, a PC, a server or a network device and so on) to implement the methods provided by the embodiments of the present invention.

The forgoing is only preferred embodiments of the present invention. It is should be noted that, improvements and modifications made by those skilled in the art without departing from the principle of the present invention should be covered by the protection scope of the present invention.

Those skilled in the art can understand the modules in the apparatus of embodiments of the present invention may be located in the apparatus as described in the embodiments, or may be located in one or more apparatuses when modified accordingly. The modules of the above embodiments may be integrated into a physical entity or be deployed separately; may be combined into one module, or be further split into several sub modules.

The index numbers of the embodiments are merely for facilitating description, and should not be interpreted to be representative for the preference order of the embodiments.

The foregoing is only some embodiments of the present invention. The protection scope of the present invention, however, is not limited to the above description. Any change or substitution that is within the scope disclosed by the present invention and can easily occur to those skilled in the art should be covered by the protection scope of the present invention.

1. A method for adjusting a size of a list item displayed on a touchscreen, the list item comprising a head portrait control and a contact panel control, the method comprising:
obtaining, by a client application, a multi-touch event; and
adjusting, by the client application, a size of the head portrait control and a size of the contact panel control according to at least one event parameter in the multi-touch event.

2. The method of claim 1, wherein the multi-touch event is a two-touch event, the at least one event parameter in the multi-touch event comprises a center point and a zoom scale of a zooming operation corresponding to the multi-touch event;
wherein the method further comprises: before adjusting the size of the head portrait control and the size of the contact panel control in the list item,
obtaining, by the client application, information of initial positions of two touch points on the touchscreen before a movement of the two touch points and information of final positions of the two touch points after the movement, determining a mid-point of the initial positions as a center point of the zooming operation, and determining a ratio of a distance between the two touch points after the movement to a distance between the two touch points before the movement as the zoom scale of the zooming operation.

3. The method of claim 2, wherein the adjusting the size of the head portrait control in the list item according to the at least one event parameter in the multi-touch event comprises:
adjusting the size of the head portrait control according to the zoom scale; and adjusting position of head portrait control based on the center point.

4. The method of claim 3, wherein the adjusting by the client application the size of the contact panel control further comprising:
adjusting size of the list item based on an adjusted size of the head portrait control; and
adjusting the size of the contact panel control based on the adjusted size of the head portrait control and an adjusted size of the list item.

5. The method of claim 4, further comprising: after the adjusting by the client application the size of the contact panel control in the list item,
adjusting, by the client application, a layout of the contact panel control according to the adjusted size of the contact panel control.

6. The method of claim 5, wherein the contact panel control comprises multiple sub elements, wherein the adjusting the layout of the contact panel control according to the adjusted size of the contact panel control comprises:
obtaining a pre-defined template which stores layout of the sub elements including size and position information of each sub element;
determining a desired size of the contact panel control for displaying the contact panel control based on the size and the position information of each sub element;
determining if the desired size is not larger than the adjusted size of the contact panel control;
displaying the contact panel control by using the pre-defined template when the desired size is not larger than the adjusted size of the contact panel control; and
obtaining another pre-defined template when the desired size is larger than the adjusted size of the contact panel control and determining another desired size of the contact panel control for displaying the contact panel control using the another template until a desired size of the contact panel control for displaying the contact panel control using the another pre-defined template is not larger than the adjusted size of the contact panel control.

7. The method of claim 6, wherein the adjusting the layout of the contact panel control according to the adjusted size of the contact panel control comprises: determining if the desired size of the contact panel control is not larger than a pre-defined minimal size; and displaying the contact panel control by using a template corresponding to the pre-defined minimal size if the desired size of the contact panel control is not larger than the pre-defined minimal size.

8. The method of claim 6, further comprising storing, in the client application, a plurality of pre-defined templates, each template storing a layout of the sub elements.

9. An apparatus for adjusting a size of a list item being displayed on a touchscreen, the list item comprising a head portrait control and a contact panel control, the apparatus comprising:
an obtaining module adapted to obtain a multi-touch event; and
an adjusting module adapted to adjust a size of the head portrait control and a size of the contact panel control according to at least one event parameter in the multi-touch event.

10. The apparatus of claim 9, wherein the multi-touch event is a two-touch event, the at least one event parameter in the multi-touch event comprises a center point and a zoom scale of a zooming operation corresponding to the multi-touch event;
the obtaining module is further adapted to obtain information of initial positions of two touch points on the touchscreen before a movement of the two touch points and information of final positions of the two touch points after the movement, determining a mid-point of the initial positions as a center point of the zooming operation, and determining a ratio of a distance between the two touch points after the movement to a distance between the two touch points before the movement as the zoom scale of the zooming operation.

11. The apparatus of claim 10, wherein
the adjusting module is further adapted to adjust the size of the head portrait control according to the zoom scale, and adjusting position of the head portrait control based on the center point.

12. The apparatus of claim 11, wherein the adjusting module is further adapted to adjust size of the list item based on an adjusted size of the head portrait control; and adjust the size of the contact panel control based on the adjusted size of the head portrait control and an adjusted size of the list item.

13. The apparatus of claim 12, wherein
the adjusting module is further adapted to adjust the layout of the contact panel control according to the adjusted size of the contact panel control.

14. The apparatus of claim 13, wherein the contact panel control comprises multiple sub elements, the adjusting module is further adapted to:
obtain a pre-defined template which stores layout information of the sub elements including size and position information of each sub element;
determining a desired size of the contact panel control for displaying the contact panel based on the size and the position information of each sub element;
display the contact panel control by using the pre-defined template when the desired size is not larger than the adjusted size of the contact panel control; and
obtain another pre-defined template when the desired size is larger than the adjusted size of the contact panel control and determine another desired size of the contact panel control for displaying the contact panel control using the another template until the desired size of the contact panel control for displaying the contact panel control using the the another pre-defined template is not larger than the adjusted size of the contact panel control.

15. The apparatus of claim 14, wherein
the adjusting module is further adapted to determine if the desired size of the contact panel control is not larger than a pre-defined minimal size; and display the contact panel by using a template corresponding to the pre-defined minimal size if the desired size of the contact panel control is not larger than the pre-defined minimal size.

16. The apparatus of claim 14, wherein the adjusting module is further adapted to store a plurality of pre-defined templates, each template storing a layout of the sub elements.

17. A non-transitory computer readable medium storing instructions executable by a processor, the instructions comprising instructions for a client application to adjust size of a list item displayed on a touchscreen, the list item comprising a head portrait control and a contact panel control;
instructions for obtaining a multi-touch event; and
instructions for adjusting a size of the head portrait control and a size of the contact panel control according to at least one event parameter in the multi-touch event.

18. The non-transitory computer readable medium in claim 17, wherein the multi-touch event is a two-touch event, the at least one event parameter in the multi-touch event comprises a center point and a zoom scale of a zooming operation corresponding to the multi-touch event, further comprising instructions for, before adjusting the size of the head portrait control and the size of the contact panel control in the list item:
instructions for obtaining information of initial positions of two touch points on the touchscreen before a movement of the two touch points and information of final positions of the two touch points after the movement, determining a mid-point of the initial positions as a center point of the zooming operation, and determining a ratio of a distance between the two touch points after the movement to a distance between the two touch points before the movement as the zoom scale of the zooming operation; and
instructions for adjusting the size of the head portrait control and size of the list item according to the zoom scale; and adjusting position of head portrait control based on the center point; and
instructions for adjusting the size of the contact panel control based on an adjusted size of the head portrait control and an adjusted size of the list item.

19. The non-transitory computer readable medium in claim 18, wherein the contact panel control comprises multiple sub elements, further comprising instructions for, after the adjusting by the client application the size of the contact panel control in the list item, adjusting the layout of the contact panel control according to the adjusted size of the contact panel, wherein the instructions for adjusting the layout of the contact panel control according to the adjusted size of the contact panel comprise:
obtaining a pre-defined template, the pre-defined template storing layout of the sub elements including size and position information of each sub element;
calculating a desired size of the contact panel control for displaying the contact panel control based on the size and the position information of each sub element;
determining if the desired size is not larger than the adjusted size of the contact panel control;
displaying the contact panel control by using the pre-defined template when the desired size is not larger than the adjusted size of the contact panel control; and
obtaining another pre-defined template when the desired size is larger than the adjusted size of the contact panel control and determining another desired size of the contact panel control for displaying the contact panel control using the another template until a respective desired size of the contact panel control for displaying the contact panel control using a respective pre-defined template is not larger than the adjusted size of the contact panel control.

20. The non-transitory computer readable medium in claim 19, further comprising instructions for determining if the desired size of the contact panel control is not larger than a pre-defined minimal size; displaying the contact panel control by using a template corresponding to the pre-defined minimal size if the desired size of the contact panel control is not larger than the pre-defined minimal size; and storing, in the client application, a plurality of pre-defined templates, each template storing a layout of the sub elements.
